(19) United States
(12) Patent Application Publication
(10) Pub. No.: US 2005/0178718 A1
(43) Pub. Date: Aug. 18, 2005

(54) Coalescing and separation arrangements systems and methods for liquid mixtures

(75) Inventors: Stephen Geibel, Cortland, NY (US); Kenneth Williamson, Jamesville, NY (US); Scott Whitney, Marathon, NY (US); Angela Griffin, Homer, NY (US); Robert James, Mississauga Ontario (CA)

Correspondence Address: LEYDIG VOIT & MAYER, LTD, 700 THIRTEENTH ST. NW, SUITE 300, WASHINGTON, DC, 20005-3960, US

(73) Assignee: PALL Corporation, EAST HILLS, NY (US)

(21) Appl. No.: 10/503,814

(22) PCT Filed: Feb. 6, 2002
(86) PCT No.: PCT/US02/03331

(51) Int. Cl. B01D 29/88

(52) U.S. Cl. 210/456; 210/512.1; 210/304

(57) ABSTRACT

Coalescing and/or separating arrangements for separating a discontinuous phase liquid from a continuous phase liquid may comprise two or more of a coalescer (30), a separator (50) and a flow director (70).

### TECHNICAL FIELD

The present invention relates to arrangements, systems, and methods for liquid/liquid separations. More particularly, the invention relates to arrangements, systems, and methods for coalescing and separating at least one immiscible liquid component, as the discontinuous phase, from another liquid component, as the continuous phase.

### BACKGROUND OF THE INVENTION

In many different types of fluid processing, it is often necessary to separate mixed immiscible liquid phases or components from one another. Common devices used to separate mixtures into individual liquid components include coalescers and separators. When two or more immiscible components are very well mixed, coalescers may be used to aid separation by causing small particles of the discontinuous phase liquid to aggregate and form larger droplets within the continuous phase liquid. The discontinuous phase liquid may be heavier or lighter than the continuous phase liquid. Separators may be used to aid separation by allowing one liquid component or phase (e.g., the continuous phase liquid) to pass through the separator while resisting or preventing passage of another liquid component or phase (e.g., the discontinuous phase liquid, such as the coalesced droplets of the discontinuous phase liquid). The continuous and discontinuous phases may thus be separated on opposite sides or surfaces of the separator. In separating liquid components from one another, a typical liquid/liquid treatment system may thus include both a coalescer and a separator depending on the characteristics of the liquid mixture.

Liquid/liquid systems may include horizontal or vertical arrangements of coalescers and separators contained within a housing or vessel. An example of a coalescing and separating arrangement is a vertically stacked arrangement wherein a coalescer is stacked, e.g., end-to-end, above or below a separator. Various exemplary coalescer and separator arrangements are disclosed, for example, in International Publication No. WO 97/38781 and U.S. Pat. No. 5,443,724, herein incorporated by reference. However, arrangements such as these and other separator and coalescer arrangements, while having many advantages, may produce less than ideal separation results in many applications and may be more expensive to manufacture than is economically feasible.

For example, poor separation may result when the continuous phase liquid has a high viscosity, e.g., is somewhat thick, and/or when the continuous and discontinuous phase liquids have similar specific gravities such that one liquid does not readily float on top of or sink to the bottom of the other liquid. Any discontinuous phase liquid which flows with the continuous phase liquid to the separator may remain in contact with the surface of many conventional separators. Discontinuous phase liquid on the surface of the separator may block the flow of continuous phase liquid through the separator.

Regardless of the viscosity or specific gravity of the liquids, poor separation may also result whenever the discontinuous phase liquid is in constant contact with and/or builds up near or on the surface of the separator, especially for high-flow rate or high velocity industrial and laboratory applications. As the flow velocity of the continuous phase liquid through the separator increases, the continuous phase liquid carries or forces more and more of the nearby discontinuous phase liquid through the separator. Thus, the quality of separation product (e.g., the continuous phase liquid) decreases because the discontinuous phase liquid is forced through the separator along with the continuous phase liquid. One approach to this problem may include periodically shutting down the operation of the system and allowing the discontinuous phase liquid to drain away from the separator. However, this approach dramatically decreases throughput, i.e., the amount of separation product that can be produced by the system in a given period of time. Another approach may include using a larger vessel and/or a larger separator. These approaches dramatically increase the cost of the system. Thus, along with issues of poor separation, industry has been confined to approaches that decrease throughput and increase equipment costs.

### SUMMARY OF THE INVENTION

The inventions described or claimed in this application may address one or more of the problems set forth above and/or many other problems associated with separating an immiscible discontinuous phase liquid from a continuous phase liquid.

In accordance with one aspect of the present invention, a liquid/liquid separation arrangement for separating a discontinuous phase liquid from a continuous phase liquid may comprise a separator and a flow director. The separator may include an upstream surface. The separator resists the passage of the discontinuous phase liquid and allows the passage of the continuous phase liquid. The flow director may be cooperatively arranged with the separator to direct the continuous phase liquid in a curvilinear flow path to the upstream surface of the separator.

In accordance with another aspect of the present invention, a liquid/liquid separation arrangement for separating a discontinuous phase liquid from a continuous phase liquid may comprise a separator and a flow director. The separator may include a separator medium, and the flow director may be mounted to the separator.

In accordance with another aspect of the present invention, a liquid/liquid coalescing arrangement for separating a discontinuous phase liquid from a continuous phase liquid may comprise a coalescer and a flow director. The coalescer may include a downstream surface. The coalescer forms smaller particles or droplets of the discontinuous phase liquid into larger droplets. The flow director may be cooperatively arranged with the coalescer to direct continuous phase liquid in a curvilinear flow path away from the downstream surface of the coalescer.

In accordance with another aspect of the present invention, a liquid/liquid coalescing arrangement for separating a discontinuous phase liquid from a continuous phase liquid may comprise a coalescer and a flow director. The coalescer may include a coalescer medium, and the flow director may be mounted to the coalescer.

In accordance with another aspect of the present invention, a liquid/liquid treatment arrangement for separating a discontinuous phase liquid from a continuous phase liquid may comprise a coalescer, a separator, and a flow director. The coalescer may include a downstream surface. The separator may include an upstream surface.

The flow director may be disposed between the downstream surface of the coalescer and the upstream surface of the separator.

In accordance with another aspect of the present invention, a liquid/liquid treatment arrangement for separating a discontinuous phase liquid from a continuous phase liquid may comprise a hollow coalescer and a separator. The hollow coalescer may have an interior, an upstream side facing the interior and a downstream side facing away from the interior of the coalescer. The separator may be positioned at least partially, and more preferably substantially or entirely, within the interior of the hollow coalescer. The separator is isolated from the upstream side of the coalescer.

In accordance with another aspect of the present invention, a liquid/liquid treatment arrangement for separating a discontinuous phase liquid from a continuous phase liquid may comprise a hollow coalescer and a separator. The hollow coalescer may have an interior, a first open end and a second open end opposite the first open end. The separator may be positioned at least partially, and more preferably substantially or entirely, within the interior of the hollow coalescer. The separator may be isolated from the first open end or the second open end of the coalescer.

In accordance with another aspect of the present invention, a liquid/liquid treatment arrangement for separating a discontinuous phase liquid from a continuous phase liquid may comprise a coalescer and a separator. The coalescer may have a coalescer medium. The separator may have a separator medium and a conical configuration, the conical separator pointing away from the coalescer.

In accordance with another aspect of the present invention, a method for separating a discontinuous phase liquid from a continuous phase liquid may comprise directing the continuous phase liquid from a coalescer in a curvilinear flow path to a separator.

In accordance with another aspect of the present invention, a method for separating a discontinuous phase liquid from a continuous phase liquid may comprise diverging the flow paths of the continuous phase liquid from the discontinuous phase liquid, including directing the continuous phase liquid along a curvilinear flow path.

In accordance with another aspect of the present invention, a method for separating a discontinuous phase liquid from a continuous phase liquid may comprise directing a mixture of the continuous phase liquid and the discontinuous phase liquid into the interior of a hollow coalescer and inside-out from the upstream side of the coalescer to the downstream side through a coalescer medium. The method may further comprise directing a continuous phase liquid into the interior of the hollow coalescer and through a separator which is isolated from the upstream side of the coalescer.

In accordance with another aspect of the present invention, a method for separating a discontinuous phase liquid from a continuous phase liquid may comprise directing a mixture of the continuous phase liquid and the discontinuous phase liquid through a first open end of a hollow coalescer and inside-out through a coalescer medium. The method may further comprise directing the continuous phase liquid through an opposite open end of the hollow coalescer and through a separator which is isolated from the first open end of the coalescer.

Embodiments of the present invention may include one or more of these various aspects of the invention. Embodiments which include a flow director and/or which direct the continuous phase liquid in a curvilinear flow path provide many advantages. For example, the discontinuous phase liquid may diverge from the flow path of the continuous phase liquid as the continuous phase liquid flows around a flow director and/or in a curvilinear flow path, for example, to a separator. Consequently, the amount of discontinuous phase liquid which comes in the vicinity of, e.g., contacts, the separator may be significantly reduced. Therefore, the separator may be mostly contacted by the continuous phase liquid and less contacted by the discontinuous phase liquid. Blockage of the separator by the discontinuous phase liquid may be minimized and little, if any, discontinuous phase liquid may be forced through the separator by the continuous phase liquid, greatly enhancing the separation efficiency and allowing smaller separators and, therefore, smaller housings to be used.

Embodiments which include a conical separator may also provide several advantages, especially for liquids that have a high viscosity or similar specific gravities. A conical separator may have a larger surface area than, e.g., a planar, or flat, separator having a similar dimension. Further, a conical separator may provide a self-cleaning action that sweeps any droplets of the discontinuous phase liquid away from the sloped surface of the separator. Thus, blockage of the separator by the discontinuous phase liquid may be reduced, the separation efficiency may be enhanced and smaller housings may be used.

Embodiments which include a separator disposed in the interior of a coalescer are also very advantageous. For example, the arrangement of the coalescer and the separator may be much more compact, e.g., shorter. Consequently, the housing may be much more compact.

### BRIEF DESCRIPTION OF THE DRAWINGS

FIG. 1 is a partial cross-section view of a fluid treatment system.

FIG. 2 is a partial cross-section view of another fluid treatment system.

FIG. 3 is a partial cross-section view of another fluid treatment system.

FIG. 4 is a partial cross-section view of another fluid treatment system.

FIG. 5 is a partial cross-section view of another fluid treatment system.

FIG. 6 is a partial cross-section view of another fluid treatment system.

FIG. 7 is a partial cross-section view of another fluid treatment system.

FIG. 8 is a partial cross-section view of another fluid treatment system.

FIG. 9 is a partial cross-section view of another fluid treatment system.

FIG. 10 is a partial cross section view of another fluid treatment system.

FIG. 11 is a partial cross section view of another fluid treatment system.

FIG. 12 is a partial cross section view of another fluid treatment system.

FIG. 13 is a partial cross section view of another fluid treatment system.

### SPECIFIC DESCRIPTION OF THE INVENTION

The present inventions may enhance the separation of immiscible liquid components of a process fluid comprising a mixture of the components. For example, the present inventions may enhance separation of one or more immiscible liquid components of the mixture, as the discontinuous phase, from one or more liquid components of the mixture, as the continuous phase.

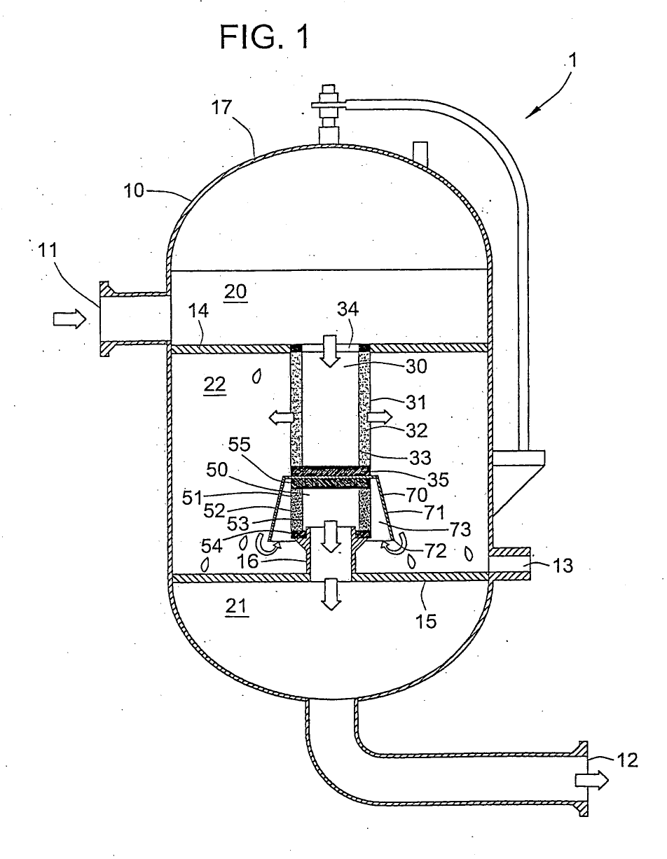

One example of a fluid, or liquid/liquid, treatment system 1 is illustrated in FIG. 1. The fluid treatment system 1 may comprise a housing or a vessel 10, one or more coalescers 30, and one or more separators 50. The housing or vessel 10 may include at least one inlet and at least one outlet. Preferably, the housing 10 may include a process fluid inlet 11 and two or more outlets, e.g., a continuous phase outlet 12 and a discontinuous phase outlet 13, and defines liquid flow paths from the process fluid inlet 11 to the continuous phase outlet 12 and to the discontinuous phase outlet 13. The inlet and the outlets may be arranged in any suitable place in the housing 10. Preferably, the inlet and outlets are arranged within the housing in locations suitable to facilitate the coalescing and separation operation.

The housing 10 may be divided by one or more partitions, such as a tube sheet 14 and/or a support plate 15, into chambers, such as a process fluid chamber 20, a coalesced liquid chamber 22, and a continuous phase chamber 21. The one or more partitions 14,15 may be fixed within the housing or removable from the housing. The housing 10 may also comprise other parts or components such as, but not limited to, one or more vents; valves, such as pressure relief valves; fittings, e.g., for pressure, temperature, and/or flow meters; and backwashing or blowback mechanisms (not shown). The housing 10 may include a removable cover 17, such as a swing-around cover, or a non-removable cover.

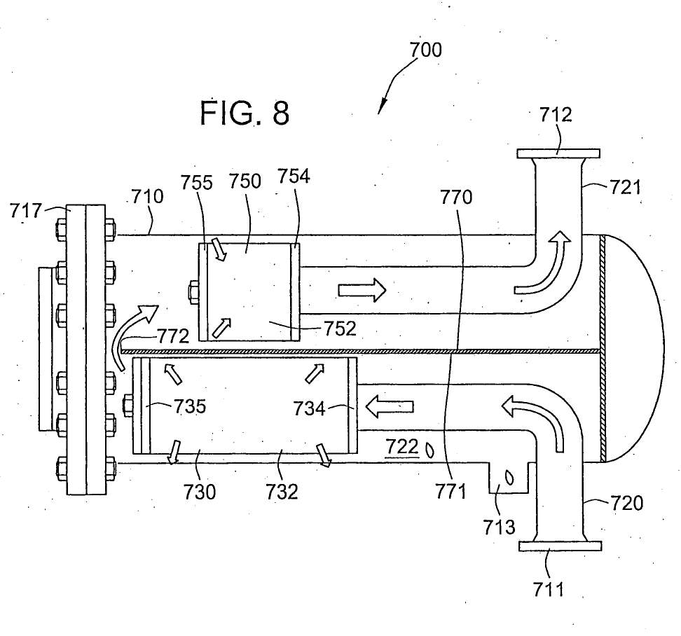

The housing or vessel 10 may comprise any housing or vessel suitable for a particular fluid treatment operation. The housing 10 may comprise any of various shapes and sizes, and may be amenable to accommodate a single coalescer 30 and/or a single separator 50 or a plurality of coalescers 30 and/or a plurality of separators 50. Preferably, the housing 10 is substantially cylindrical in shape and has a longitudinal axis; however, any suitable shape that facilitates separation and houses the various fluid treatment arrangements may be employed. The housing may include a slant or slope, such as, a slanted or sloped partition or wall to assist, for example, in the removal of any settled or pooled liquid. Such a structure may comprise a wall of the housing or partition within the housing. The longitudinal axis of the housing may have any suitable orientation, for example, vertical, horizontal, or any suitable angle in between. “Horizontal” may include any configuration of housings, coalescers, and separators where the average direction of the principal axis of the element is more horizontal than vertical. “Vertical” may include any configuration of housings, coalescers, and separators where the average direction of the principal axis of the element is more vertical than horizontal. FIG. 1 shows an example of a vertical housing 10 and FIG. 8 shows an example of a horizontal housing 710. Preferably, the housing may be dimensioned and/or oriented to gravitationally and/or fluid-dynamically assist the coalescing and/or separating operation.

The housing 10 may comprise any suitable material which is capable of providing sufficient structural integrity for the particular coalescing and separating operation and which will not adversely react with liquids being processed or hinder the separation operation. The housing 10 may be, for example, a plastic or a metal. Preferably, the housing comprises a metal, even more preferably a non-reactive metal. The housing may, for example, comprise a stainless steel and/or a carbon steel. The housing may be constructed such that it remains structurally stable in the presence of high pressures, temperatures, and/or flow rates. The housing 10 may further comprise any suitable design, material, or construction characteristics or any components or combinations, for example, as described in International Publication No. WO 97/38781.

Each coalescer 30 may be arranged in any suitable configuration within the housing. For example, the coalescer 30 may be arranged axially parallel to the axis of the housing, either along or offset from the axis of the housing. In the case of more than one coalescer 30, any spacing between the coalescers 30 suitable for coalescence may be used. For example, the coalescers 30 may be spaced closely to one another or spaced further apart. The coalescers 30 may be directly attached to the housing 10, e.g., via a partition 15, such as a tube sheet or support plate, or via stand-off tubes 16.

Two or more coalescer cartridges may be joined together in open-end to open-end relation to increase the length of the coalescer 30. For example, two coalescer cartridges may be joined by joiner end caps or open end caps. Further, if more than one coalescer 30 is placed within a housing 10, the coalescers 30 may have substantially equal lengths or may be unequal in length. For example, one coalescer 30 may include only one coalescer cartridge and another coalescer 30 may include more than one coalescer cartridge.

The coalescer 30 may comprise any type of coalescer suitable for a particular fluid treatment operation. For example, the coalescer 30 may comprise any suitable material, shape, or configuration to effectuate the coalescence of the discontinuous phase liquid. The coalescer 30 may comprise a substantially cylindrical, planar, polygonal, or conical configuration. While any suitable configuration or shape may be used, the coalescer 30 preferably has a hollow, cylindrical configuration.

The coalescer 30 may comprise any of various components. For example, the coalescer 30 may comprise a coalescer medium 32, one or more end caps 34, 35, an inner support structure 33, and/or an outer support structure 31. If more than one end cap is included, at least one of a first end cap 34 and a second end cap 35 may be open to allow liquid to flow through the end cap to or from the interior of the coalescer 30 and at least one of the first end cap 34 and the second end cap 35 may be closed or blinded to prevent liquid from flowing through the end cap. In the illustrated embodiment of FIG. 1, the first end cap 34 may be open, fluidly communicating the upstream side, e.g., the interior, of the coalescer 30 through an opening in the tube sheet 14 with the process fluid chamber 20 and the process fluid inlet 11. The second end cap 35 may be closed. The inner support structure 33 may comprise a perforated core and the outer support structure 31 may comprise a cage. The inner and outer support structures may be perforated, permeable, foraminous, or any suitable configuration that directs and/or allows liquid to flow therethrough. The coalescer 30 may also include, but is not limited to, one or more of an alignment element, a sealing collar, a fastener, a final classifier, and a perforated wrap. The coalescer 30 may further include a permanent or removable filter element (not shown). The coalescer 30 may be permanently fixed within the housing 10, or preferably, the coalescer 30 may be removably associated within the housing 10, e.g., removably mounted to the tube sheet 14. The coalescer 30 may be disposable and/or cleanable.

The coalescer medium 32 may comprise any material suitable for a coalescer in an application for which the coalescer is employed. For example, the coalescer medium 32 may comprise any porous structure which forms small immiscible discontinuous liquid particles or droplets into larger droplets. The coalescer medium 32 may comprise fibrous materials, such as a fibrous mass, fibrous mats, woven or non-woven fibrous sheets; may comprise porous membranes such as supported or non-supported microporous membranes; or may comprise a mesh or screen. The coalescer medium 32 may comprise inorganic or organic fibers or filaments. Exemplary organic fibers may include polymeric fibers or microfibers made from, for example, polyolefins (e.g., polyethylene), polyesters (e.g., polyethylene terephthalate), polyamides (e.g., nylon), fluoropolymers, and copolymers, mixtures, and blends thereof. Inorganic fibers may include fibers such as glass or metal fibers, such as metal titanates, e.g., potassium titanate. The coalescer medium 32 may include a surface treatment such as a coating or a surface modifying treatment. The coalescer medium 32 may have or may be modified to have any desired critical wetting surface tension (CWST). For example, the CWST may be intermediate the surface tensions of the continuous phase and discontinuous phase liquid components. In particular, the CWST may be between the surface tensions of the continuous phase liquid and the discontinuous phase liquid. CWST, in units of dynes/cm, may be defined as the mean value of the surface tension of a liquid which is absorbed and that of a liquid of neighboring surface tension which is not absorbed into the surface of the medium. CWST is defined, for example, in U.S. Pat. No. 5,443,724 and U.S. Pat. No. 5,480,547, both of which are herein incorporated by reference. The coalescer medium 32 may have a uniform or graded pore structure and any appropriate and/or effective pore size. Preferably the coalescer medium 32 includes a graded pore size that increases from the upstream side to the downstream side. For example, the pore size may be graded in a stepwise or continuous manner, e.g., where the pore size increases from the upstream to the downstream side of the coalescer medium 32. The coalescer 32 medium may be configured in a non-pleated or a pleated arrangement. When the coalescer medium 32 is pleated, the pleats may be straight, radially extending from the axis of the coalescer, or they may be arranged as set forth in U.S. Pat. No. 5,543,047. The coalescer 30 may be any suitable size appropriate for the types of liquid components being separated and the particular processing conditions, such as, flow rates, temperatures, and pressures. The coalescer 30 may further comprise any suitable design, material, construction features, or any components as described in International Publication No. WO 97/38781, U.S. Pat. No. 4,759,782 and U.S. Pat. No. 5,480,547, and International Publication No. WO 98/14257, all incorporated herein by reference.

Each separator 50 may be arranged in any suitable configuration within a housing 10. For example, the separator 50 may be arranged axially parallel to the axis of the housing, either along or off-set from the axis of the housing. The separator 50 may be directly attached to the housing 10, e.g., via a partition, such as a support plate or tube sheet, or via a stand-off tube 16.

Two or more separator cartridges may be joined together in open-end to open-end relation to increase the length of the separator 50. For example, two separator cartridges may be joined by joiner end caps or open end caps. Further, when there is more than one separator 50, the separators 50 may have substantially equal lengths or may have unequal lengths. For example, one separator 50 may include only one separator cartridge and another separator 50 may include more than one separator cartridge.

The separator 50 may comprise a wide variety of suitable materials, shapes, or configurations to promote the separation of the discontinuous phase liquid from the continuous phase liquid. For example, the separator 50 may preferably be hollow. The separator 50 may comprise a substantially cylindrical configuration, a conical configuration, such as a truncated right circular conical or a frusto-conical configuration, or a planar configuration, such as a polygonal, annular, disc-shaped, quoit-shaped, or a toroid-shaped configuration. A disc-shaped configuration may comprise a right circular cylinder whose length is small compared with its diameter. A quoit-shaped configuration may comprise a flat, centrally bored, right circular cone shape. A toroid-shaped configuration may comprise a ring-like body. The separator 50 may also include a planar, slanted, and/or sloped configuration. Further, the separator 50 may be any suitable size appropriate for the types of liquid components being separated and the particular processing conditions, such as, flow rates, temperatures, and pressures.

The separator 50 may comprise any of various components including, for example, one or more end caps 54, 55, an inner support structure 53, an outer support structure 51, and/or a separator medium 52. In the case where the separator 50 comprises two end caps, at least one of a first end cap 55 and a second end cap 54 may be open to allow liquid to flow through the end cap and at least one of the first end cap 55 and the second end cap 54 may be closed to prevent liquid from flowing through the end cap. In the illustrated embodiment of FIG. 1, the first end cap 55 may be closed or blinded and the second end cap 54 may be open, fluidly communicating the downstream side of the separator 50 through an opening in the stand-off tube 16 with the continuous phase liquid chamber 21 and the continuous phase outlet 12. The inner support structure 53 may comprise a perforated core and the outer support structure 51 may comprise a cage. The inner and outer support structures may be perforated, permeable, foraminous, or any suitable configuration that directs and/or allows fluid to flow therethrough. The separator 50 may be permanently fixed within the housing 10, or preferably, the separator may be removably associated within the housing 10. The separator 50 may be disposable and/or cleanable.

The separator medium 52 may comprise any type of medium suitable for allowing passage of the continuous phase liquid while resisting passage of a discontinuous phase liquid. For example, the separator medium 52 may be arranged such that the continuous phase liquid wets the separator medium 52 and the discontinuous phase liquid does not wet the separator medium 52. The separator medium 52 may comprise any of various materials, for example, liquiphobic materials, such as hydrophobic or oleophobic materials, and/or may have a surface modification treatment, such as a coating. For many applications in which water is the discontinuous phase liquid, the separator preferably comprises a hydrophobic medium. The separator medium 52 may comprise, for example, a coated stainless steel screen or a pleated fibrous pack. Preferably, the separator medium 52 comprises a polyester woven or nonwoven screen, which may be treated with a surface treatment, such as one available under the trade designation REPEL available from Pall Corporation, or a Teflon® coated screen, a hydrophobic paper, or a woven fluoropolymer screen. The separator medium 52 may have a uniform or graded pore structure and any appropriate effective pore size. The pore size may be any suitable size to effectuate separation and the pores may be regularly or irregularly spaced, shaped, or sized. Preferably, the nominal pore size of the separator medium 52 is smaller than the size of the coalesced discontinuous phase liquid droplets. For example, the pore rating of the separator medium 52 may be about 1001μ or less, or 401μ or less or 20μ or less or 10μ or less, e.g., 8-10μ. The separator 50 may further comprise any suitable design, material, or construction characteristics or any components or combinations, such as those described in International Publication No. WO 97/38781 or U.S. Pat. No. 5,443,724.

There are various ways in which the coalescer 30 and the separator 50 may be arranged. For example, the coalescer 30 and the separator 50 may be positioned in a vertically stacked arrangement, for example, wherein the coalescer 30 and the separator 50 are positioned end-to-end along their axes as shown, for example, in FIG. 1. Another suitable arrangement may comprise a horizontally orientated coalescer and a horizontally oriented separator within a housing, for example, where a horizontal coalescer is positioned above or below a horizontal separator as shown, for example, in FIG. 8. In an arrangement where the coalescer and separator are stacked vertically and where the continuous phase liquid is less dense than the discontinuous phase liquid, the coalescer 30 is preferably positioned above the separator 50. In an embodiment where the discontinuous phase liquid is less dense than the continuous phase liquid, the coalescer 30 is preferably positioned below the separator 50. On the other hand, in an arrangement where the coalescer and the separator are stacked horizontally and where the continuous phase liquid is less dense than the discontinuous phase liquid, the separator is preferably positioned above the coalescer.

The coalescer 30 and separator 50 may be arranged along the same axis or along different or off-set axes from themselves and/or one another. In an embodiment where coalescers 30 and separators 50 are arranged along the same axis, a coalescer 30 may be joined together in end-to-end relation with a separator 50. For example, a blind end cap of a coalescer 30 may be associated with, e.g., abut, a blind end cap of a separator 50, such that the coalescer 30 and separator 50 are joined in a closed-end to closed-end relation.

The ratio of coalescers 30 to separators 50 within the housing may be 1:1, or there may be more coalescers 30 than separators 50 or more separators 50 than coalescers 30. Further, one or more coalescers 30 may be vertically arranged above or below a plurality of separators 50, or one or more separators 50 may be arranged below or above a plurality of coalescers 30. Where more than one coalescer 30 is used, the coalescers 30 may have the same diameter, width, and length as each other, or may have different diameters, widths, and lengths from one another. Where more than one separator 50 is used, the separators 50 may have the same diameter, width, and/or length as each other, or may have different diameters, widths, and/or lengths from one another. For example, the diameter, width, and/or length of the coalescers 30 and separators 50 may be the same as or different from one another. Further some coalescers 30 and some separators 50 may have the same diameter, width, and/or length as one another, while others may have different diameters, widths, or lengths from one another.

Flow through the coalescer 30 and the separator 50 may be outside-in flow through the coalescer 30 and inside-out flow through the separator 50. Preferably, flow through the coalescer 30 is inside-out, and flow through the separator 50 is outside-in. However, any suitable operational flow-through arrangement may be employed. For example, flow may be inside-out for all of the coalescers and separators, or flow may be outside-in for all of the coalescers and separators, depending on the configuration and arrangement of the coalescers and the separators in the housing.

In the discussion of the illustrated embodiments, arrangements suitable for a discontinuous phase liquid which is denser than continuous phase liquid are shown, and many of these embodiments, especially the vertical embodiments, preferably have the coalescer positioned above the separator. However, the inventions are not limited to these embodiments or arrangements. The inventions may also be applicable to other arrangements, including the inverse of the described and illustrated arrangements, e.g., wherein the discontinuous phase liquid is less dense than the continuous phase liquid and the coalescer is positioned below the separator. Some alternative embodiments are described in detail and these embodiments illustrate many alternative features. The inventions may cover any combination of these and additional features.

The exemplary fluid treatment system 1 shown in FIG. 1 illustrates a preferred configuration where the process fluid comprises an immiscible mixture including a discontinuous phase liquid and a continuous phase liquid which is less dense than the discontinuous phase liquid. In this embodiment, one or more coalescers 30 and one or more separators 50 are disposed within a housing or vessel 10 with the coalescers 30 above the separators 50. Process fluid entering the system 1 may enter the housing or vessel 10 through the process fluid inlet 11 and pass to the interior of the housing in the process fluid chamber 20. The tube sheet 14 may contain one or more openings directly associated with one or more open coalescer end caps 34, allowing fluid to flow from the process fluid chamber 20 into the interior of each hollow coalescer 30.

The process fluid may then flow through the coalescer 30 from the upstream side, e.g., the interior, to the downstream side, e.g., the exterior, of the coalescer 30, where the small particles or droplets of the discontinuous phase liquid in the process fluid are coalesced to form larger droplets. The coalesced discontinuous phase liquid and the continuous phase liquid passing through the coalescer 30 may enter the coalesced liquid chamber 22. The discontinuous phase liquid, the denser component, may pass to a lower portion of the coalesced liquid chamber 22, which may be formed by a wall of the housing 10 or a partition 15, such as a support plate. The discontinuous phase liquid may then exit the housing 10 through the discontinuous phase outlet 13 which may be located in a wall of the coalesced liquid chamber 22.

The continuous phase liquid passes from the coalesced liquid chamber 22 through the separator medium 52 of the separator 50 from the upstream side, e.g., the exterior, to the downstream side, e.g., the interior, of the separator 50, while the separator medium 52 resists passage of any discontinuous phase liquid. From the separator 50, the continuous phase liquid passes through the stand-off tube 16 and through the one or more openings in the partition 15, such as a support plate, and into the continuous phase chamber 21. The continuous phase liquid may then exit the housing 10 through the continuous phase outlet 12 in fluid communication with the continuous phase chamber 21.

To reduce the amount of discontinuous phase liquid which passes in the vicinity of the separator 50 or contacts the separator 50, the separator 50 may be positioned on the stand off tube 16 above the lower portion of the coalesced liquid chamber 22, and/or the separator 50 may have a CWST which resists passage of the discontinuous phase liquid. However, in accordance with a first aspect of the invention, a flow director 70 may be arranged with the housing 10, the coalescer 30 and/or the separator 50 to even more effectively enhance the separation of the continuous and discontinuous phase liquids, for example, to further reduce the amount of discontinuous phase liquid which passes in the vicinity of, e.g., contacts, the separator 50.

The flow director 70 is preferably cooperatively arranged to direct at least a portion or, preferably, all of the continuous phase liquid in a curvilinear flow path. A curvilinear flow path includes any flow path that is not straight. Preferably, a curvilinear flow path includes a bend, e.g., a bend toward the separator. The continuous phase liquid may be directed along one or more than one curvilinear flow path. For example, all of the continuous phase liquid may flow along the same curvilinear flow path, or a portion of the continuous phase liquid may flow along one curvilinear flow path while a different portion may flow along a second curvilinear flow path. Further, there may be a variety of curvilinear flow paths through which portions of continuous phase liquid may flow.

The flow director 70 may thus enhance separation of a discontinuous phase liquid from a continuous phase liquid by diverging the flow paths of the continuous phase liquid from the discontinuous phase liquid, e.g., by directing the continuous phase liquid along a curvilinear flow path toward the separator 50 and by diverging the discontinuous phase liquid from the curvilinear flow path away from the separator 50. The flow director 70 may be cooperatively arranged with a separator 50 to direct continuous phase liquid in a curvilinear flow path to the upstream surface of the separator 50 and/or the flow director 70 may be cooperatively arranged with a coalescer 30 to direct continuous phase liquid in a curvilinear flow path away from the downstream surface of the coalescer. Preferably, the flow director 70 is positioned between a coalescer 30 and a separator 50, e.g., between the downstream side of the coalescer 30 and the upstream side of the separator 50, to direct continuous phase liquid in a curvilinear flow path from a downstream surface of the coalescer 30 to an upstream surface of the separator 50, the discontinuous phase liquid diverging from the curvilinear flow path, for example, to the lower portion of the coalesced liquid chamber 22. The discontinuous phase liquid may diverge from the continuous phase liquid for a variety of reasons, e.g., due to projectile motion, gravitational forces, inertial forces, and/or other fluid dynamics.

The flow director 70 may be cooperatively arranged, for example, with one or more of the separator 50, the coalescer 30, and the housing 10. Depending on the direction of flow through the coalescer 30 and separator 50, the flow director 70 may be positioned at the exterior of the separator 50, near the interior the separator 50, near the exterior of the coalescer 30, near the interior of the coalescer 30, and/or between the downstream side of the coalescer 30 and the upstream side of the separator 50. The flow director 70 may be removably or permanently fixed in any arrangement suitable to facilitate separation. For example, the flow director 70 may be directly associated with a coalescer end cap 35, a separator end cap 55, or between a coalescer end cap 35 and a separator end cap 55. The flow director may be directly associated with a coalescer 30 and/or a separator 50 by being permanently or removably attached, fixed, bonded, welded, adhered, or any suitable means of associating. Further, the flow director may be directly associated via an intermediary piece or connection, such as via a gasket or a flange. Preferably, flow director 70 and at least one of and, even more preferably, both of the coalescer 30 and the separator 50 are permanently or removably attached to one another to form an integral unit that can be easily mounted to and removed from the housing 10. Further, the flow director 70 may be indirectly associated with the coalescer 30 and/or the separator 50 by being mounted to or, part of, the housing 10 and/or any structural member within the housing 10, such as a flow diverting partition, barrier, or wall.

The flow director 70 may comprise a wide variety of materials, shapes, positions, and orientations. For example, the flow director 70 may be oriented in any suitable way to direct the continuous phase fluid in a curvilinear flow path. The flow director 70 may be arranged to extend in a planar configuration. For example, the flow director 70 may be substantially perpendicular to the axis of the coalescer 30 and/or the separator 50. Alternatively, the flow director 70 may have a hollow configuration, e.g., a hollow conical or cylindrical configuration. The flow director 70 may be arranged to surround the exterior of the coalescer 30 and/or the separator 50, e.g., as a skirt or shroud, or align along the interior of the coalescer 30 and/or the separator 50. Further, the flow director 70 may extend along part of, all of, or more than the axial length of the coalescer 30 and/or separator 50. Thus, the length of the flow director 70 may be shorter than, equal to, or longer than, the length of the separator 50 and/or coalescer 30. For example, the flow director 70 may extend longitudinally along the upstream surface of the separator 50 about 25% or more of the length of the separator 50, e.g., about 50% or more, about 80% or more, about 90% or more, about 95% or more, or about 100% or more of the length of the separator 50.

The flow director 70 may be spaced from the upstream surface of the separator 50 or the downstream surface of the coalescer 30 to form a gap between itself and the separator 50 and/or coalescer 30. The flow director 70 may extend along the separator 50 or coalescer 30 at any suitable angle from the axis of the separator 50 or coalescer 30. For example, the flow director 70 may extend at an angle from about 0 degrees or greater to about 180 degrees or less from the central axis of the separator 50 and/or the central axis of the coalescer 30. The gap may thus be uniform or tapered along the length of the separator 50 or coalescer 30.

The flow director 70 may comprise any suitable shape to direct the continuous phase liquid in a curvilinear flow path. For example, the flow director 70 may comprise a substantially cylindrical, hollow configuration. The flow director 70 may comprise a substantially conical, hollow configuration, such as a truncated right circular conical or a frusto-conical configuration. The flow director 70 may have a closed end and an open end which may be spaced farther from the coalescer 30 than the closed end and may open away from the coalescer 30. The flow director 70 may comprise a polygonal, including circular, configuration, such as an annular, disc-shaped, quoit-shaped, or a toroid-shaped configuration. The flow director 70 may also include a planar, slanted, and/or sloped configuration, such as a barrier or partition. Further, the flow director 70 may be any regular or irregular shape. An irregular shape may comprise, for example, a helmet-shape or any variations of the above-described shapes, such as corrugated or including furrows.

The flow director 70 may include one or more portions suitable to direct the continuous phase liquid in a curvilinear flow path. For example, the flow director 70 may comprise a surface 71 and an edge 72. The flow director 70 is preferably suitable to allow the continuous phase liquid and the discontinuous phase liquid to flow along or to move past the surface 71. Further, the flow director 70 is preferably constructed to direct the continuous phase liquid in a curvilinear flow path, such that the curvilinear flow path may bend around the edge 72. The flow director 70 may bend the flow of all or at least a portion of the continuous phase liquid from the coalescer 30 back to the separator 50 through one or more bends. Each bend may be in the range from greater than about 0 degree to about 360 degrees or more. Preferably, the bend may comprise about 90 degrees or greater, about 180 degrees or greater, about 220 degrees or greater, or about 360 degrees or more. The flow director 70 may direct discontinuous phase flow away from the separator 50, e.g., by diverging the discontinuous phase flow from the continuous phase flow at or near the edge 72 of the flow director 70.

The flow director 70 may comprise any suitable material compatible with a particular fluid treatment operation. For example, the flow director 70 preferably comprises an impervious material, such as an impervious metal or plastic material. However, the flow director 70 may comprise a porous, permeable, semi-permeable, or perforated material that allows the passage of some liquid through it, while directing a substantial portion of the continuous phase liquid along a curvilinear flow path to the separator 50 and a substantial portion or all of the discontinuous phase liquid away from the separator 50.

Liquid passing from the downstream side of the coalescer 30 may pass by and/or contact the flow director 70 and flow or drain along the flow director surface 71. The continuous phase liquid preferably flows along the curvilinear flow path and bends around the flow director 70 to and through the separator medium 52 of the separator 50. The discontinuous phase liquid may continue flowing past the edge 72 of the flow director 70 and away from the vicinity of the separator 50, e.g., to the lower portion of the coalesced liquid chamber 22 if the discontinuous phase liquid is denser than the continuous phase (or to the upper portion of the coalesced liquid chamber 22 if the discontinuous phase liquid is less dense).

There are many advantages associated with using a flow director in a liquid/liquid treatment system. In particular, a flow director may minimize the amount of discontinuous phase liquid that comes in the vicinity of, e.g., into contact with, the separator. Therefore, the separator may be mostly contacted by the continuous phase liquid and less contacted by the discontinuous phase liquid, greatly enhancing the separation efficiency. Further, the chance that the separator may become blinded by the discontinuous phase liquid is significantly reduced. Production times may be lengthened, without any shut-down periods being necessary for draining the discontinuous phase liquid from the separator. Further, a smaller separator may be used, which, in turn, may allow a smaller housing, thus reducing the overall equipment and manufacturing costs.

In FIG. 1, a flow director 70 is illustrated as comprising a conical configuration while the separator 50, including the separator medium 52, has a hollow cylindrical configuration. The flow director 70 is spaced from and extends axially along the exterior of a separator 50, which may be along the upstream surface of the separator 50, forming a gap 73 between the flow director 70 and the separator 50. The gap 73 may be tapered, the open end of the gap 73 being larger than the closed end. For example, the diameter of the flow director 70 at the edge 72 may be up to about 25% greater or more than the diameter of the separator 50, while the diameter at the closed end of the flow director 70 may be about equal to the diameter of the separator 50. Further, in this embodiment, the flow director 70 may be directly associated with the coalescer 30 or the separator 50. For example, the flow director may be mounted to or part of the blind coalescer end cap 35 or the blind separator end cap 55, or may be mounted within the housing between the coalescer 30 and the separator 50. The flow director 70 may extend below a lower end of the separator 50 such that the edge 72 of the flow director is shown to extend beyond the length of the separator 50.

From the downstream surface of the coalescer 30, the coalesced discontinuous phase liquid and the continuous phase liquid flow past the flow director 70. Near the edge 72 of the flow director 70, the continuous phase liquid flows along a curvilinear flow path to the separator 50 and through the separator medium 52. The continuous phase liquid flow bends under the edge 72 of the flow director 70 and enters the tapered gap 73 between the flow director 70 and the separator 50, as indicated by the arrows in FIG. 1. The heavier discontinuous phase liquid generally diverges from the continuous phase liquid flow path. Rather than following the curvilinear flow path of the continuous phase liquid, the discontinuous phase liquid may generally pass to the lower portion of the coalesced liquid chamber 22 and hence through the discontinuous phase outlet 13. Consequently, the amount of discontinuous phase liquid in the vicinity of the separator 50, e.g., in the gap 73, is significantly reduced. With less discontinuous phase liquid in the vicinity of the separator 50, the continuous phase liquid passes easily through the separator 50 without carrying or forcing significant amounts, if any, of the discontinuous phase liquid along with it. From the interior, e.g., the downstream side, of the separator 50, the continuous phase liquid passes through the stand-off tube 16 into the continuous phase chamber 22 and hence through the continuous phase outlet 12.

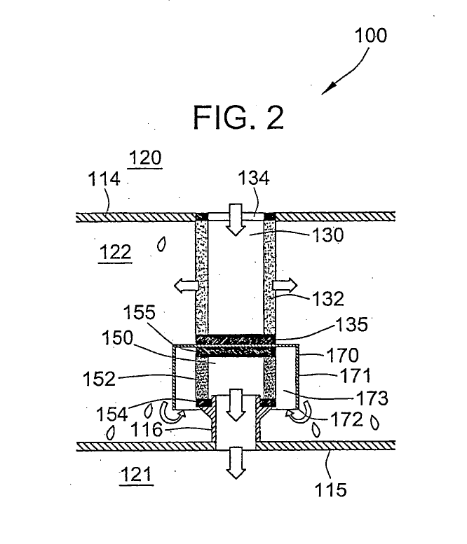

Another fluid, or liquid/liquid, treatment system 100 is shown in FIG. 2. This system preferably includes many elements, such as a housing (not shown), coalescer 130, flow director 170 and separator 150, which may have one or more of any of the features described with respect to the other embodiments, especially the embodiment shown in FIG. 1. For example, the housing may include a tube sheet 114, a support plate 115 and a process fluid chamber 120; the coalescer 130 may include a coalescer medium 132, an open end cap 134 and a blind end cap 135; the separator 150 may include an open end cap 154 and a closed end cap 155; and the flow director 170 may include a surface 171. (Elements of one illustrated system which generally correspond to elements of another illustrated system may be identified by reference numerals having the same last two digits.) In the embodiment shown in FIG. 1, the flow director 70 is generally conical and extends axially beyond the separator. However, a flow director is not limited to these features. For example, as shown in FIG. 2, the flow director 170 may comprise a cylindrical configuration and may be spaced from and extend along the exterior of a cylindrical separator 150 only a part of the length of the separator 150, the flow director 170 being shorter than the separator 150. For example, the flow director 70 may extend from less than about 25% to less than 100% of the length of the separator 50. A uniform gap 173 may be formed between the separator 150 and the flow director 170 instead of a tapered gap. Again, the flow director 170 may be directly associated with any of the coalescer 130, the separator 150, or the housing.

Flow of the continuous phase liquid and the discontinuous phase liquid may be similar to that described with respect to the other embodiments, especially the embodiment shown in FIG. 1. The continuous phase liquid may flow from the downstream surface of the coalescer 130 in a curvilinear flow path around the edge 172 of the flow director 170 to contact the separator 150. The continuous phase liquid may then flow through the separator medium 152 of the separator 150 beyond, e.g., below, the edge 172 of the flow director 170 or it may flow into the gap 173 and then through the separator medium 152 of the separator 150. The continuous phase liquid may then pass through the stand-off tube 116 into the continuous phase chamber 121 and hence to the continuous phase outlet (not shown). The flow of discontinuous phase liquid may diverge from the curvilinear flow path of the continuous phase liquid, e.g., at the edge 172 of the flow director 170, flowing away from the separator 150 to the lower portion of the coalesced liquid chamber 122.

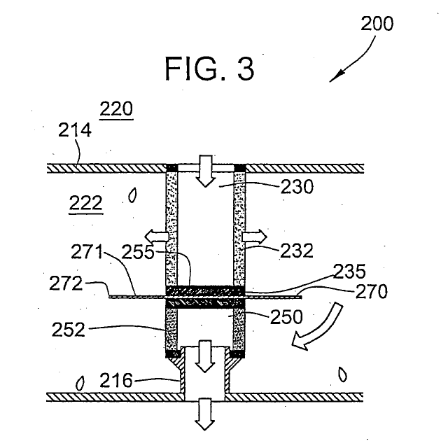

Another fluid, or liquid/liquid, treatment system 200 is illustrated in FIG. 3. This system also preferably includes many elements, such as a housing (not shown), coalescer 230, and separator 250, which may have one or more of any of the features described with respect to the other embodiments. For example, the housing may include a tube sheet 214 and a process fluid chamber 220, the coalescer 230 may include a coalescer medium 232, and the flow director 270 may include a surface 271. However, the flow director 270 shown in FIG. 3 has a substantially planar configuration, extending outward from the coalescer 230 and separator 250, e.g., at about 90 degrees to the axis of the coalescer 230 and/or the separator 250. The flow director 270 may comprise a circular configuration, such as an annular or disc-shaped configuration. Alternatively, the flow director 270 may comprise any other polygonal configuration or a toroidal, quoit, sloped, slanted, and/or irregular configuration. The flow director 270 may have a diameter up to about 25% or more greater than the diameter of the coalescer and/or separator. The flow director 270 may be associated with the coalescer 230, the separator 250, or the housing.

Flow of the continuous phase liquid and discontinuous phase liquid may be similar to that described with respect to the other embodiments. The continuous phase liquid, represented by the arrows in FIG. 3, may flow from the downstream surface of the coalescer 230 in a curvilinear flow path to bend around the flow director edge 272 back to and through the separator medium 252 of the separator 250. From the separator 250, the continuous phase liquid may flow through the stand-off tube 216 into the continuous phase chamber (not shown) and hence to the continuous phase outlet (not shown). The discontinuous phase liquid, represented by droplets in FIG. 3, may flow from the downstream surface of the coalescer 230, diverge from the curvilinear path of the continuous phase liquid and pass to the lower portion of the coalesced liquid chamber 222 and hence to the discontinuous phase outlet (not shown).

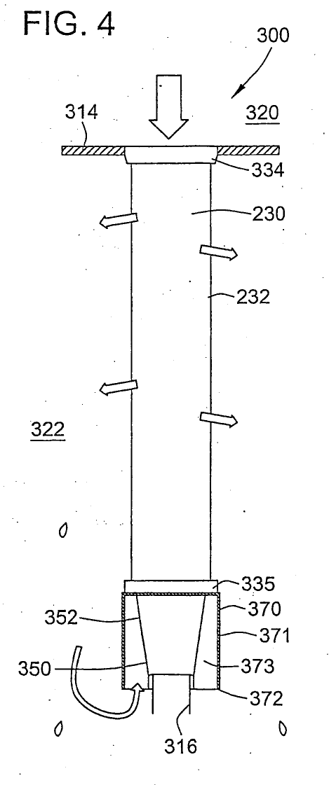

Another fluid, or liquid/liquid, treatment system 300 is illustrated in FIG. 4. This system also preferably includes many elements, such as a housing (not shown), coalescer 330, flow director 370, and separator 350, which may have one or more of any of the features described with respect to the other embodiments, especially the embodiments shown in FIG. 1 and FIG. 2. For example, the housing may include a process fluid chamber 320, the coalescer 330 may include a coalescer medium 332 extending between an open end cap 334 and a blind end cap 335, and the flow director 370 may include a surface 371. However, the separator 350, including the separator medium 352, preferably comprises a hollow, substantially conical configuration, as shown in FIG. 4. The separator 350 is preferably tapered in a vertical direction. For example, the apex of the conical separator preferably points downward in a system designed for a discontinuous phase liquid which is denser or heavier than the continuous phase liquid (or upward for a system designed for a less dense or lighter discontinuous phase liquid). Conical separators are mentioned in API/IP Specification No. 1582, “Specification for Similarity for API/IP 1581 Aviation Jet Fuel Filter/Separators,” published jointly by The American Petroleum Institute and the Institute of Petroleum, London, UK, February, 2001.

A conically configured separator, especially a conically configured, nonpleated separator, may have many advantages. For example, the conical configuration may provide a larger surface area in the liquid flow path of the continuous phase liquid, e.g., a larger surface area within the envelope defined by a flow director. Further, a conical configuration may provide a self-cleaning action. This self cleaning action may be highly advantageous for separating liquid mixtures wherein the continuous phase liquid has a high viscosity (e.g., a viscosity greater than or equal to about 10 centipoise, such as ≧20, ≧30, ≧35 or ≧40 centipoise) or wherein the continuous phase liquid and the discontinuous phase liquid have similar specific gravities. Any droplet of the discontinuous phase liquid which reaches the sloped surface of a conical separator medium may experience a net force which sweeps the droplet away from the surface of the separator. While the beneficial effect of a sloped surface may be observed at many angles, a more preferred angle for the surface is in the range from about 15° to about 75°, more preferably about 20° to about 70°, more preferably about 30° to about 60°, e.g., more preferably about 45°, to the axis of the separator.

The flow director 370 may have any suitable configuration. For example, the flow director 370 may have a cylindrical configuration, forming a tapered gap 373 between the flow director 370 and the conical separator 350, or a conical configuration, forming, for example, a uniform gap. The flow director 370 may extend axially less then, equal to or greater than the length of the separator 350 and may have a diameter greater than the coalescer 330 and/or separator 350. Preferably, the diameter of the flow director 370 is less than or equal to the diameter of the coalescer 330, e.g., less than or equal to the diameter of the open end cap 334 of the coalescer 330, and the coalescer 330 and the flow director 370 are arranged generally coaxially. The coalescer 330, flow director 370, and separator 350 may then be attached to one another and mounted, for example, as an integral unit to the housing, e.g., through an opening in the tube sheet 314.

Flow of the continuous phase liquid and the discontinuous phase liquid may be similar to that described with respect to the other embodiments, especially the embodiments shown in FIG. 1 and FIG. 2. The continuous phase liquid, represented by the arrows in FIG. 4, flows from the downstream surface of the coalescer 330 in a curvilinear flow path around the flow director edge 372 into the tapered gap 373 to the upstream surface of the separator 350 and through the separator medium 352. From the downstream side of the separator 350, the continuous phase liquid may flow through the stand-off tube 316 into the continuous phase chamber (not shown) and hence to the continuous phase outlet (not shown). The discontinuous phase liquid may flow past the flow director 370, diverging from the curvilinear path of the continuous phase liquid and away from the separator 350 to the lower portion of the coalesced liquid chamber 322, and then pass to the discontinuous phase outlet (not shown).

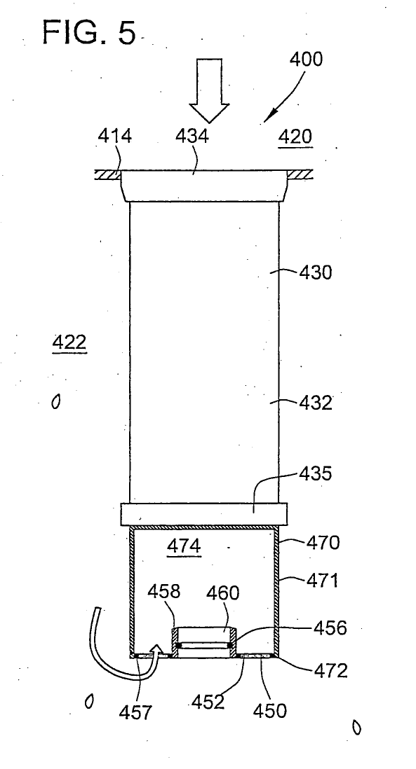

Another fluid, or liquid/liquid, treatment system 400 is illustrated in FIG. 5. This system also preferably includes many elements, such as a housing (not shown), coalescer 430, flow director 470 and separator 450, which may have one or more of any of the features described with respect to the other embodiments. For example, the housing may include a tube sheet 414 and a process fluid chamber 420, the coalescer 430 may include a coalescer medium 432 extending between an open end cap 434 and a blind end cap 435, and the flow director 470 may include a surface 471. The separator may have a hollow cylindrical or a hollow conical configuration, e.g., with the apex of the conical separator pointing up or down. However, in FIG. 5, the separator 450 may have a generally polygonal geometry, such as circular, square, hexagonal or octagonal, and a substantially planar configuration, such as an annular, disc-shaped, quoit-shaped, or toroid-shaped configuration. Further, the separator 450 may comprise a slanted or sloped configuration. The flow director 470 may extend in the liquid flow path between the coalescer 430 and the separator 450 and may have any suitable configuration as previously described. The flow director 470 is shown as having a substantially cylindrical configuration and a diameter less than or substantially equal to the diameter of the coalescer 430.

In the illustrated embodiment, the separator medium 452 of the separator 450 has a generally planar, disc-shaped configuration and may be positioned within the flow director 450 substantially perpendicular to the axis of the flow director 470. The flow director 470 and the separator 450 are preferably joined at an open end of the flow director 470 near the edge 472 of the flow director 470 either permanently or with a removable seal 457 to prevent bypass around the separator 450. The opposite end of the flow director 470 may be closed by a blind end of the flow director 470 or by a blind end of the coalescer 430, defining a space 474 inside the flow director 470 downstream of the separator medium 452. The separator 450 may include a fitting 458 defining an opening 460 in which the stand-off tube (not shown) may be mounted. The separator 450 may be sealed to the fitting 458. The interior space 474 downstream of the separator 450 fluidly communicates with the stand-off tube via the opening 460, and an O-ring or other seal 456 is preferably positioned in removable sealing engagement between the fitting 458 of the separator 450 and the stand-off tube.

Flow of the continuous phase liquid and the discontinuous phase liquid may be similar to that described with respect to the other embodiments. The continuous phase liquid may flow from the downstream surface of the coalescer 430 in a curvilinear flow path around the flow director edge 472 through the separator medium 452 of the separator 450 into the interior space 474. While the flow director 470 is preferably impervious, the flow director 470 may comprise a material which resists or prevents flow of the discontinuous phase liquid but is permeable to the continuous phase liquid. Thus, continuous phase liquid may flow directly through the flow director 470 and/or along the curvilinear path by making a bend around the edge 472 of the flow director 470 and passing through the disc-shaped separator medium 452. From the interior space 474, the continuous phase liquid flows through the opening 460 in the fitting 458 into the stand-off tube (not shown) and hence to the continuous phase chamber (not shown) and the continuous phase outlet (not shown). The discontinuous phase liquid may flow along the flow director 470 and diverge from the curvilinear flow path of the continuous phase liquid away from the separator 450 to the bottom of the coalesced liquid chamber 422 and hence to the discontinuous phase outlet (not shown).

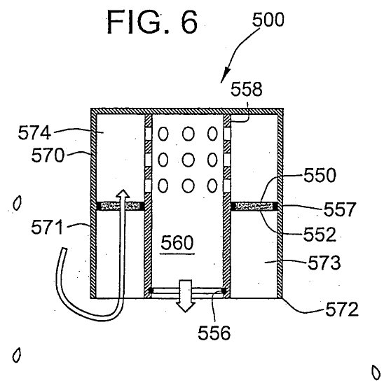

Another fluid, or liquid/liquid, treatment system 500 is illustrated in FIG. 6. This system may also include many elements, such as a housing (not shown), coalescer (not shown), separator 550 and flow director 570, which may have one or more of any of the features described with respect to the other embodiments, especially the embodiment shown in FIG. 5. For example, the flow director 570 may have a generally cylindrical configuration defining a surface 571, an open end at the edge 572 of the flow director 570, and a closed end opposite the open end which may be attached to the coalescer While the separator 550 may include a separator medium 552 having a hollow cylindrical or conical configuration, in the illustrated embodiment the separator medium 552 has a circular geometry and a generally planar configuration. The separator medium 552 may be arranged in a plane substantially perpendicular to the axis of the flow director 570. However, unlike the separator medium 452 of FIG. 5 which is substantially flush with the edge 472 of the flow director 470, the separator medium 552 of FIG. 6 is preferably positioned within the flow director 570 at a distance from the edge 572. The separator medium 552 may be disposed at any suitable distance from the edge 572 of the flow director 570 that is between the edge 572 and the closed end of the flow director 570 and may be sealed to the flow director 570 by a seal 557. The separator 550 may also include a fitting 558 defining an opening 560. The fitting 558 may have a first portion that extends into the interior space 574 formed by the downstream side of the separator medium 552 and the flow director 570, the first portion having one or more holes, such as an open end or slots or perforations in a side wall, that fluidly communicate between the interior space 574 and the opening 560 in fitting 558. The fitting 558 may also have a second portion that extends beyond, e.g., below, the separator medium 552 and is preferably impervious, defining a gap 573 between the second portion of the fitting 558, the upstream side of the separator medium 552 and the flow director 570. The second portion of the fitting 558 may be sealed to a stand-off tube (not shown) by an O-ring 556 or other seal.

Flow of the continuous phase liquid and the discontinuous phase liquid may be similar to that described with respect to the other embodiments, especially the embodiment shown in FIG. 5. The continuous phase liquid, represented by the arrows in FIG. 6, may flow from the downstream side of the coalescer (not shown) past the flow director 570 in a curvilinear flow path around the edge 572 of the flow director 570 into the gap 573. From the gap 573 the continuous phase liquid contacts the separator 550 and flows through the separator medium 552 into the interior space 574. From the interior space 574 the continuous phase liquid flows into the opening 560 of the fitting 558 through the stand-off tube (not shown) into the continuous phase chamber (not shown) and through the continuous phase outlet (not shown). The discontinuous phase liquid may flow from the downstream side of the coalescer 530 past the flow director 570. The discontinuous phase liquid may then diverge from the curvilinear flow path of the continuous phase liquid away from the separator 550 and pass to the lower portion of the coalesced liquid chamber 522 and hence to the discontinuous phase outlet (not shown).

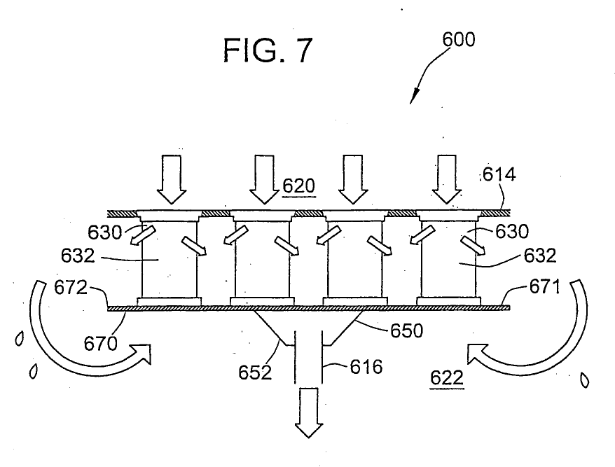

Another fluid, or liquid/liquid, treatment system 600 is illustrated in FIG. 7. This system may also preferably include many elements, such as a housing (not shown), coalescer 630, flow director 670, and separator 650, which may have one or more of any of the features described with respect to the other embodiments. For example, the housing may include a tube sheet 614 and a process fluid chamber 620, the coalescer 630 may include a coalescer medium 632, and the flow director 670 may include a surface 671. The fluid treatment system 600 includes two or more coalescers, e.g., four coalescers 630, arranged above and in fluid communication with fewer separators, e.g., a single separator 650. The coalescers 630 are illustrated as comprising a cylindrical configuration; however, the coalescers may comprise any suitable configuration, such as conical. Further, the separator 650 is illustrated as comprising a conical configuration; however, the separator may comprise any suitable configuration, such as cylindrical or planar. In addition, more than one separator 650 may be used. A flow director 670 is illustrated as being positioned between the coalescers 630 and separator 650. As illustrated, the flow director 670 may comprise a planar configuration and a polygonal, e.g., circular, geometry. The flow director may also comprise any suitable configuration as discussed above, such as a conical or cylindrical configuration. The invention is not limited to the number of or the particular arrangement of coalescers, separators and flow director illustrated in FIG. 7. For example, the coalescers may be positioned in one or more rows or clusters and a separator and a flow director may be associated with each row or cluster.

Flow of the continuous phase liquid and the discontinuous phase liquid may be similar to the other embodiments. Process fluid may be directed into the process fluid chamber 620 and, for example, inside-out through the coalescers 630. The continuous phase liquid, represented by the arrows in FIG. 7, may flow from the downstream side of the coalescers 630 in a curvilinear flow path around the edge 672 of the flow director 670 and contact the separator 650. The continuous phase liquid may then flow through the separator medium 652 through the stand-off tube 616 into the continuous phase chamber (not shown) and hence to the continuous phase outlet (not shown). The discontinuous phase liquid, represented by droplets in FIG. 7, may flow from the downstream side of the coalescers 630 past the edge 672 of the flow director 670. The discontinuous phase liquid may then diverge from the curvilinear flow path of the continuous phase liquid and pass and to the lower portion of the coalesced liquid chamber 622 and hence to the discontinuous phase outlet (not shown).

For many fluid treatment systems, the housing, as well as the coalescers and/or separators, may be oriented generally vertically. However, fluid treatment systems may also be oriented generally horizontally, as shown, for example, in FIG. 8. The fluid, or liquid/liquid, treatment system 700 illustrated in FIG. 8 may include many elements, such as a housing 710, coalescer 730, flow director 770, and separator 750, which may have one or more of any of the features described with respect to the other embodiments. However, the housing 710, one or more of the coalescers 730, and one or more of the separators 750 are each oriented generally horizontally. Alternatively, a coalescer and/or a separator may be oriented vertically within a horizontal housing or may be oriented horizontally within a vertical housing.

The housing 710 may have a wide variety of suitable configurations and may include many of the features previously described with respect to the vertical housings in the other embodiments. For example, the housing 710 may comprise one or more fluid inlets and outlets, such as a process fluid inlet 711, a continuous phase outlet 712, and a discontinuous phase outlet 713, and a removable cover 717. Further, the housing may be divided into one or more chambers. In the illustrated embodiment, the housing 710 may include a single fluid chamber 722 e.g., a coalesced liquid chamber. However, the housing may include one or more partitions which divide the housing into two or more chambers, e.g., a process fluid chamber, a coalesced fluid chamber, and a continuous phase fluid chamber. The housing 710 preferably has a generally cylindrical configuration, the axis of the housing extending generally horizontally.

While only a single coalescer 730 and a single separator 750 are shown in the housing 710 illustrated in FIG. 8, the fluid treatment system 700 may include two or more coalescers and/or two or more separators, each of which are preferably oriented horizontally. The coalescer 730 may have a generally cylindrical configuration and one or more end caps, e.g., an open end cap 734 and a blind end cap 735. Similarly, the separator 750 may have a generally cylindrical configuration and one or more end caps, e.g., a blind end cap 755 and an open end cap 754. Alternatively, the separator 750, as well as the coalescer 730, may have any other suitable configuration including a conical, a circular, or a planar configuration.

The separator(s) 750 and the coalescer(s) 730 may be positioned within the housing 710 in a variety of ways. For process fluids in which the discontinuous phase liquid is heavier than the continuous phase liquid, the separator 750 is preferably positioned in a horizontal fluid treatment system laterally above the coalescer 730, as shown in FIG. 8, either directly above or offset from the coalescer 730. For process fluids in which the discontinuous phase liquid is lighter, the separator may be positioned in a horizontal fluid treatment system laterally below the coalescer. Alternatively, regardless of which phase is heavier, the separator may be positioned at the same height as the coalescer, e.g., coaxially in front of or behind the coalescer or beside the coalescer, or at a different height above or below the coalescer. The coalescer(s) and the separator(s) may be supported in the housing by any suitable support mechanism, including, for example, a tube sheet, support plate, or a mechanical connection such as a tie rod assembly. In the illustrated embodiment, the coalescer 730 and the separator 750 are supported by an inlet pipe 720 fluidly communicating between the coalescer 730 and the process fluid inlet 711 and an outlet pipe 721 fluidly communicating between the separator 750 and the continuous phase fluid outlet 712, respectively.

The horizontal fluid treatment system 700 further includes a flow director 770 which is preferably cooperatively arranged to direct the continuous phase liquid in a curvilinear flow path. The flow director 770 may thus promote separation of the discontinuous phase liquid from the continuous phase liquid, for example by diverging the flow paths of the discontinuous phase liquid from the continuous phase liquid, e.g., by directing a portion or all of the continuous phase liquid along a curvilinear flow path toward the separator 750 and by diverging a portion or all of the discontinuous phase liquid away from the separator 750. The flow director 770 is preferably positioned between the coalescer 730 and the separator 750 such that it directs the continuous phase liquid from the downstream side of the coalescer 730 in a curvilinear flow path to the separator 750. Further, in a horizontal embodiment, at least a portion of the flow director 770 is preferably sloped or slanted to allow discontinuous phase liquid to drain away from the separator 750 and/or flow director 770.

The flow director may be directly associated with the separator 750 or the coalescer 730 or both the separator 750 and the coalescer 730. For example, the flow director 770 may comprise a conical or a cylindrical configuration spaced from and extending along and around the downstream surface of the coalescer 730 or a group of coalescers 730 and/or along and around the upstream surface of the separator 750 or a group of separators 750. Preferably the flow director 770 comprises a partition or barrier between the coalescer 730 and the separator 750 and includes a surface 771. The partition or barrier may, for example, have a planar, or curved configuration and may be sloped in any suitable direction to allow discontinuous phase liquid to drain away from the separator 750. The partition or barrier may extend between the coalescer 730 and the separator 750 laterally and/or longitudinally across all or a portion of the interior of the housing 710 and/or it may have openings through which the continuous phase liquid may flow in a curvilinear flow path to the separator 750. The flow director 770 preferably is arranged to direct liquid flowing from the coalescer 730 past the coalescer 730 toward one or both ends and/or sides of the housing or vessel 710 and then bend to the separator 750. The flow director 770 is preferably directly associated with the housing 710, e.g., permanently or removably positioned within the housing 710. For example, the flow director 770 may be directly mounted to the housing 710, e.g., as a partition within the housing 710 or may comprise a part of the housing 710.

The fluid treatment system 700 shown in FIG. 8 illustrates a preferred configuration where the process fluid comprises an immiscible mixture including a discontinuous phase liquid and a continuous phase liquid which is less dense than the discontinuous phase liquid. However, the invention is not limited to an embodiment for separating a denser discontinuous phase liquid from a less dense continuous phase liquid as previously explained.

A process fluid entering the system 700 may enter the housing or vessel 710 through a process fluid inlet 711 and pass through the inlet pipe 720, isolating the process fluid from the coalesced liquid chamber 722. The inlet pipe 720 may be associated with one or more open coalescer end caps 734, e.g., directly or via a manifold, allowing process fluid to flow into the interior of each coalescer 730. The fluid then flows inside-out through the coalescer medium 732 of the coalescer 730 from the upstream surface to the downstream surface of the coalescer 730, where the small particles or droplets of the discontinuous phase liquid in the continuous phase liquid are coalesced to form larger droplets. The coalesced discontinuous phase liquid and the continuous phase liquid passing through the coalescer 730 may enter the coalesced liquid chamber 722.

From the downstream surface of the coalescer 730 the continuous phase liquid flows along a curvilinear flow path flow, represented by the arrows in FIG. 8, around the flow director 770 to the separator 750. The continuous phase liquid bends around the edge 772 of the flow director 770 and passes through the separator medium 752 through the outlet pipe 721 to the continuous phase outlet 712. From the downstream surface of the coalescer 730 the discontinuous phase liquid may generally diverge from the continuous phase liquid. Rather than following the curvilinear flow path of the continuous phase liquid, the discontinuous phase liquid may diverge from the curvilinear flow path and pass to the lower portion of the coalesced liquid chamber 722 away from the separator 750. Thus, the amount of discontinuous phase liquid in the vicinity of the separator 750 may be significantly reduced. Separation may be enhanced, for example, because the separator medium 752 is not blinded by the discontinuous phase liquid and/or because the continuous phase liquid may pass easily through the separator 750 without carrying or forcing significant amounts, if any, of the discontinuous phase liquid with it. In an embodiment where the flow director 770 includes a slope or slant, any discontinuous phase liquid in the vicinity of the separator 750 may be assisted in draining away from the separator 750 and back to the lower portion of the coalesced liquid chamber 722. From the lower portion of the coalesced liquid chamber 722, the discontinuous phase liquid exits the housing or vessel 710 via the discontinue phase outlet 713.

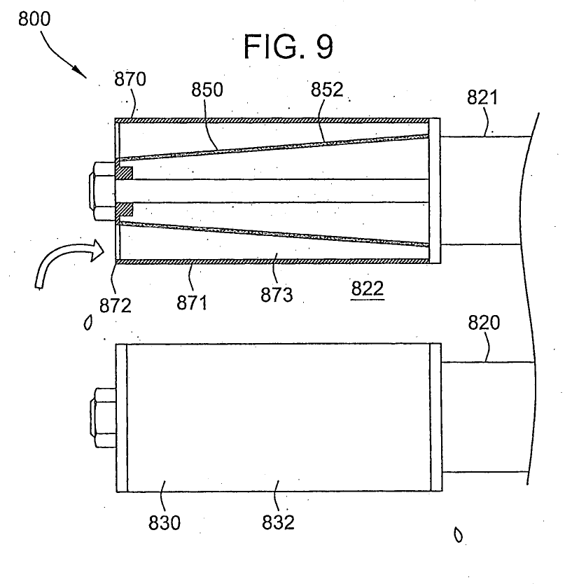

Another horizontal fluid, or liquid/liquid, treatment system 800 is shown in FIG. 9. This system may include many elements, such as a housing (not shown), coalescer 830, separator 850 and flow director 870, which may have one or more of any of the features described with respect to the other embodiments, especially the embodiment shown in FIG. 8. For example, the coalescer 830 may be supported by an inlet pipe 820 and may include a coalescer medium 832. A horizontal separator 850 may be arranged laterally above the horizontal coalescer 830, and the flow director 870 may be disposed between them. However, in the fluid treatment system 800 shown in FIG. 9, the flow director 870 may have a generally cylindrical configuration and may be cooperatively associated with, e.g., attached coaxially to, the separator 850. The separator 850 may have a generally conical configuration, and a horizontally oriented conical separator 850 may have advantages similar to those described with respect to the vertically oriented conical separator 350 of the embodiment shown in FIG. 4. Alternatively, the flow director and the separator may have any other suitable configuration. For example, the flow director may have a conical configuration and/or the separator may have a cylindrical or generally planar configuration.

The flow director 870 may surround the separator 850, e.g., as a skirt or shroud, and define a surface 871 and a gap 873 between the flow director 870 and the separator 850, e.g., a tapered gap 873. The flow director 870 preferably extends axially substantially the full length or more of the separator 850. The flow director 870 may also extend axially substantially the full length or more of the coalescer 830. In the illustrated embodiment, the separator 850 preferably has an open end fluidly communicating with outlet pipe 821 and an opposite closed end, and the flow director 870 preferably has a closed end at the outlet pipe 821 and an opposite open end. The lower region of the flow director 870 may be sloped downward toward the open end to allow any discontinuous phase liquid that may enter the open end of the flow director 870 to drain from the interior of the flow director 870. The flow director 870 and the separator 850 may be attached, for example, to the outlet pipe 821 in various ways, e.g., by a mechanical connection, such as a tie rod assembly or a screw-on attachment.

Flow of the continuous phase liquid and the discontinuous phase liquid may be similar to that described with respect to the other embodiments, especially the embodiment shown in FIG. 8. The continuous phase liquid may flow from the downstream side of the coalescer 830 in a curvilinear path around the edge 872 of the flow director 870 into the gap 873. From the gap 873, the continuous phase liquid may contact the upstream side of the separator 850, flow through the separator medium 852 into the interior of the separator 850, and pass through the open end of the separator 850 into outlet pipe 821 and hence to the continuous phase outlet (not shown). The discontinuous phase liquid may diverge from the curvilinear flow path of the continuous phase liquid, e.g., at or near the edge 872 of the flow director 870, and pass to the bottom of the coalesced liquid chamber 822, where it exits the housing or vessel (not shown) via the discontinuous phase outlet (not shown).

Each of the previous fluid treatment systems preferably includes a separator. However, in accordance with a second aspect of the invention, a fluid treatment system may comprise a flow director downstream of a coalescer but be free of a separator.

Fluid treatment systems comprising a flow director but no separator may be advantageous for many types of immiscible liquid/liquid mixtures, including mixtures in which the continuous phase liquid and the discontinuous phase liquid have significantly different specific gravities. For example, the specific gravities may differ by about 10% or more with respect to the smaller specific gravity.

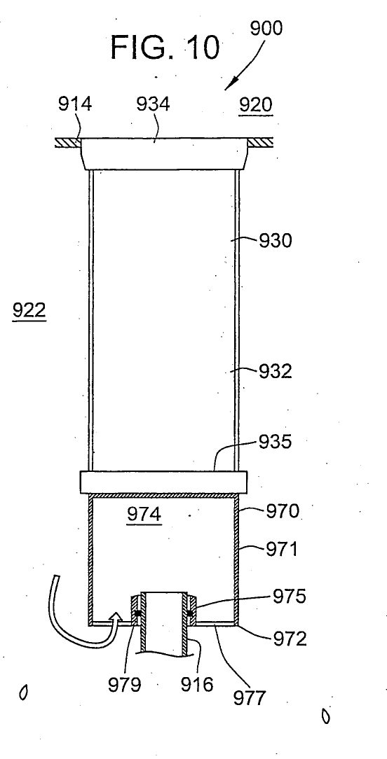

One example of a fluid, or liquid/liquid, treatment system 900 comprising a flow director 970 and without a separator is shown in FIG. 10. The system 900 may include many elements, such as a housing (not shown), coalescer 930, and flow director 970, which may have one or more any of the features described with respect to the other embodiments, except this system does not have a separator.

The coalescer 930 may be variously configured but preferably comprises a hollow conical or cylindrical configuration, including a coalescer medium 932 extending between an open end cap 934 and a blind end cap 935. The interior of the coalescer 930 fluidly communicates with the process fluid chamber 920 via the open end cap 934. The flow director 970 also preferably has a hollow conical or cylindrical configuration, including a blind end, which may abut the closed end cap 935 of the coalescer 930, and an open end, which may be spaced axially from and open away from the coalescer 930. Preferably, the coalescer 930 and the flow director 970 are permanently or removably attached as an integral unit and may be mounted to or removed from the housing as an integral unit. For example, the coalescer 930 and the flow director 970 may have diameters which enable them to be mounted to the tube sheet 914 by slipping them through the opening in the tube sheet 914, similar to the previous embodiments.

The continuous phase chamber preferably communicates with an interior space 974 of the flow director 970, for example, via a stand-off tube 916. The stand-off tube 916 preferably contacts and is secured to the flow director 970. For example, the flow director 970 may include a fitting 975 similar to the fitting 458 of FIG. 5 or the fitting 558 of FIG. 6. A perforated structural member 977, such as a spider or a perforated plate, may join the fitting 975 to the side wall of the flow director 970, either at the edge 972 of the flow director 970 as shown in FIG. 10 or inward from the edge 972. For example, a perforated structural member may be substituted for the separator medium 552 shown in FIG. 6. The fitting 975 may be sealed to the stand-off tube 916, for example, via an O-ring or other seal 979.

As another example, the flow director may have a planar configuration and a polygonal geometry, e.g., a disc-shaped configuration and a circular geometry. One or more coalescers may be positioned on one side of the flow director, e.g., above the flow director. For example, the planar flow director may be attached to the blind ends of one or more coalescers perpendicular to the axes of the coalescers, the diameter of the flow director preferably being larger than the diameter of the coalescer or the cluster of the coalescers. A stand-off tube may open into the coalesced liquid chamber near the flow director, e.g., near the center below the flow director. This embodiment may be similar to the embodiment shown in FIG. 7 without the separator 650.

Flow of the continuous phase liquid and the discontinuous phase liquid may be similar to that described with respect to the other embodiments, especially the embodiments shown in FIGS. 5 and 6, except the continuous phase liquid does not flow through a separator. The continuous phase liquid may flow from the downstream side of the coalescer 930 in a curvilinear flow path around the edge 972 of the flow director 970. The continuous phase liquid may, for example, flow away from the coalescer 930 generally axially along the side wall of the flow director, bending around the edge 972 of the flow director 970. The continuous phase liquid then passes axially in the opposite direction into the interior space 974 and then through the fitting 977 to the stand-off tube 916. As another example, the continuous phase liquid may flow away from the coalescer or cluster of coalescers generally radially outwardly along the flow director bending in a curvilinear flow path around the outer edge of the flow director. The continuous phase liquid then passes in the opposite direction radially inwardly along the opposite side of the flow director to the stand-off tube. From the stand-off tube 916, the continuous phase liquid passes into the continuous phase chamber (not shown) and hence to the continuous phase outlet (not shown). The discontinuous phase liquid may flow from the downstream side of the coalescer 930 (or cluster or coalescers) past the edge 972 of the flow director 970 and diverge from the curvilinear flow path of the continuous phase liquid, passing away from the opening in the stand-off tube 916 to the lower portion of the coalesced liquid chamber 922 and hence to the discontinuous phase outlet (not shown).

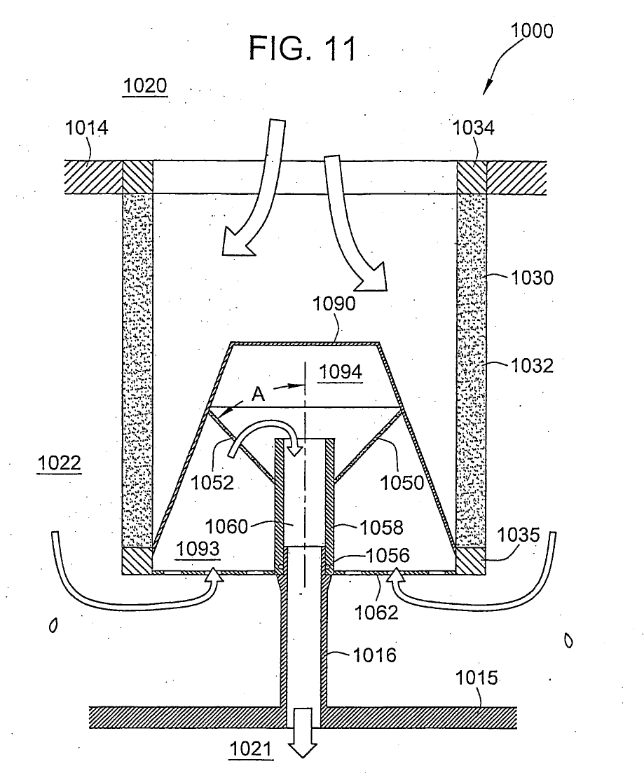

Each of the previous fluid treatment systems preferably includes a flow director. However, in accordance with a third aspect of the invention, a fluid treatment system may comprise a separator downstream of a coalescer but be free of a flow director. One example of a fluid, or liquid/liquid, treatment system 1000 comprising a coalescer 1030 and a separator 1050 without a flow director is shown in FIG. 11. The system 1000 may include many elements, such as a housing (not shown), coalescer 1030 and separator 1050, which may have one or more of all the features described with respect to the other embodiments, except this system 1000 does not have a flow director.

The coalescer 1030 may be variously configured but preferably comprises a hollow conical or cylindrical configuration having an interior. A coalescer medium 1032, which may be pleated or nonpleated, may be disposed between first and second open end caps 1034, 1035 at opposite first and second open ends of the coalescer 1030. One of end caps, e.g., the first end cap 1034, may be sealed to the housing e.g., may be sealingly mounted the tube sheet 1014. The coalescer medium 1032 has an interior surface facing the interior of the coalescer 1030, which is preferably an upstream surface, and an exterior surface facing away from the interior of the coalescer 1030, which is preferably a downstream surface. The coalescer 1030 may also include one or more additional elements as previously described.

The separator 1050 is preferably positioned at least partially within, more preferably substantially entirely within, and even more preferably entirely within the hollow coalescer 1030. The separator 1050 and the coalescer 1030 are preferably permanently or removably attached as an integral unit which can be conveniently mounted to or removed from a housing. By positioning the separator 1050 within the coalescer 1030, the arrangement of the coalescer 1030 and the separator 1050 may be more compact, e.g., shorter, enabling the coalescer and the separator to be housed within a smaller housing or vessel.

The separator 1050 may be variously configured and may include one or more of the elements previously described. For example, the separator 1050 may include a separation medium 1052, and the separation medium 1052 may be disposed at an angle A to the longitudinal axis of the separator 1050. The angle A may be in the range from about 0° to about 180°, the separation medium 1052 having a hollow generally cylindrical configuration where the angle A equals about 0° (or 180°) or a hollow, generally planar configuration where the angle A equals about 90°. Preferably, the separation medium has a nonpleated, hollow, generally conical configuration and the angle A is in the range from about 30° to about 60°, e.g., about 45°. Preferably, the apex of the conical separator 1050 points toward the second open end of the coalescer 1030.

The separator 1050 may also include a fitting 1058 which may be sealed to the separation medium 1052, e.g., at any suitable distance from the end of the coalescer 1030. The fitting 1058 preferably defines an opening 1060 that fluidly communicates When the downstream side of the separator medium 1052, e.g., via an open end of the fitting 1058 or via perforations or slots in the fitting 1058. The fitting 1058 may be attached to a stand-off tube 1016 and sealed to the stand off tube 1016, for example, via an O-ring or other seal 1056, allowing fluid communication between the stand-off tube 1016 and the opening 1060 in the fitting 1058. The fitting 1058 may also be attached to the coalescer 1030, for example, via a spider or a perforated plate 1062.

A barrier assembly 1090 is preferably positioned within the coalescer 1030 between the coalescer medium 1032 and the separation medium 1052. The barrier assembly may have a one-piece or a multipiece construction and may be a separate element or may be part of the coalescer or the separator. The barrier assembly 1090 serves as a barrier between process fluid which enters, for example, the first open end of the coalescer 1030 and the continuous phase liquid which enters, for example, the second open end of the coalescer 1030. The barrier assembly isolates the separator from the open end or open end cap through which the process fluid enters the coalescer and from the upstream side of the coalescer. Consequently, the barrier assembly 1090 preferably comprises an impervious material such as an impervious metal or plastic.

The barrier assembly 1090 may be configured in a wide variety of ways. For example, the barrier assembly 1090 may have a generally cylindrical or a generally conical configuration. As shown in FIG. 11, the conical barrier assembly is preferably oriented with the apex pointing toward the first open end of the coalescer and may be truncated. The barrier assembly 1090 is preferably sealed against both the coalescer 1030 and the separator 1050 and may be attached to one or more of the housing, the coalescer 1030 and the separator 1050. In the illustrated embodiment, the barrier assembly 1090 may be attached and sealed to the second end cap 1035 of the coalescer 1030 and to the separation medium 1052, terminating beyond the separation medium 1052. Alternatively, the separator may include a blind end cap attached to the separator medium and the barrier assembly may extend between the second open end cap of the coalescer and the blind end cap of the separator. Within the coalescer 1030, the barrier assembly 1090 and the separator 1050 define a gap 1093 upstream of the separator medium 1050 and an interior space 1094 downstream of the separator medium 1052.

Flow of the continuous phase liquid and the discontinuous phase liquid may be similar to that described with respect to the other embodiments, except the continuous phase liquid does not flow along or around a flow director. Process fluid may enter the interior of the coalescer 1030, for example, from the process fluid chamber 1020 through the first open end cap 1034 at the first open end of the coalescer 1030 and pass along one side of the barrier assembly 1090 to the coalescer medium 1032. The conical configuration of the barrier assembly 1090 may enhance distribution of process fluid to the coalescer medium 1032. The process fluid then flows inside-out from the upstream surface, e.g., the interior surface, of the coalescer 1030 to the downstream surface e.g., the exterior surface, through the coalescer medium 1032, where the small particles or droplets of the discontinuous phase liquid are coalesced to form larger droplets.

From the downstream surface of the coalescer 1030 the continuous phase liquid flows in a curvilinear flow path around the second open end cap 1035 and, preferably back through the second open end of the coalescer 1030. The continuous phase liquid then flows into the interior of the coalescer 1030 in the gap 1093 along the other side of the barrier assembly 1090 to the separation medium 1052 of the separator 1050, which is isolated from the upstream side of the coalescer 1030. From the gap 1093 the continuous phase liquid 1052 flows through the separator medium 1052, which resists passage of any discontinuous phase liquid, and into the interior space 1094 downstream from the separator medium 1052. From the interior space 1094 the continuous phase liquid flows through the opening 1060 in the fitting 1058 through the stand-off tube 1016 into the continuous phase chamber 1021 and hence to the continuous phase outlet (not shown). The discontinuous phase liquid may flow from the downstream side of the coalescer 1030 past the coalescer medium 1032 and the second end cap 1035. The discontinuous phase liquid may then diverge from the curvilinear flow path of the continuous phase liquid away from the separator 1050 and pass to the lower portion of the coalesced liquid chamber 1022. Any discontinuous phase liquid which reaches the separator 1050 may drain from the separator medium 1052, especially the conically-shaped separator medium 1052, and pass to the lower portion of the coalesced liquid chamber 1022. From the lower portion of the coalesced liquid chamber 1022, the discontinuous phase liquid may pass to the discontinuous phase outlet (not shown).

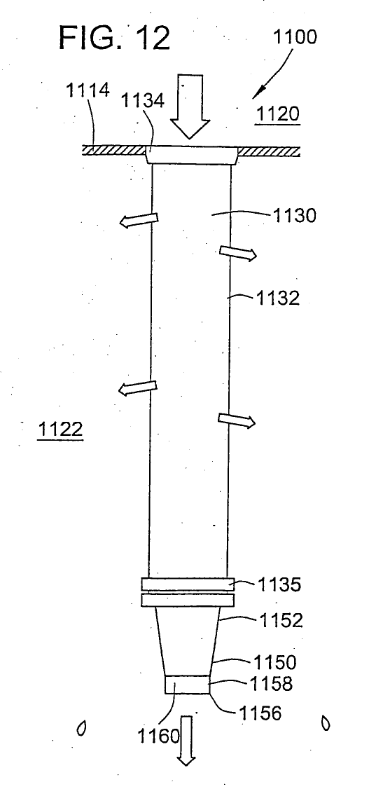

Another fluid, or liquid/liquid, treatment system 1100 is illustrated in FIG. 12. This system may also include many elements, such as a housing (not shown), coalescer 1130 and separator 1150, which may have one or more of any of the features described with respect to the other embodiments, especially the embodiments shown in FIG. 4 and FIG. 11, except this system 1100 does not include a flow director. Further, the separator 1150 in this system 1100 is preferably disposed substantially outside of, more preferably completely outside of, the coalescer 1130.

The coalescer 1130 may have a hollow, generally cylindrical or conical configuration and a coalescer medium 1032 extending between first and second end caps 1134, 1135. The first end cap 1134 is preferable open, while the second end cap 1135 is preferably blind.

The separator 1150 is disposed downstream of the coalescer 1130 and may be permanently or removably mounted to the housing, e.g., a stand-off tube, or, preferably, the coalescer 1130, e.g., to the blind end cap 1135 of the coalescer 1130. While two or more coalescers may be associated with each separator, each coalescer 1130 is preferably associated with a single separator 1150. The separator 1150 and the coalescer 1130 are preferably arranged coaxially, and the diameter of the separator 1150 is preferably substantially equal to or less than the diameter of the coalescer 1130, enabling them to be mounted or removed through an opening in the housing, for example, through an opening in a tube sheet 1114, as an integral unit. While the coalescer 1130 and separator 1150 may be oriented horizontally, they are preferably oriented vertically.

While the separator 1150 may have any suitable configuration, a nonpleated, conical configuration where the apex of the conical separator 1150 points away from the coalescer 1130 is most preferred. The separator 1150 may include any of the elements previously described, including a separator medium 1152 and a blind end cap mounted to one end of the separator medium 1152. The blind end cap of the separator 1150 may be attached to the blind end cap 1135 of the coalescer 1130. Alternatively, the separator medium may be mounted directly to the blind end cap of the coalescer. The separator 1150 may also include a fitting 1158 joined to the other end of the separator medium 1152 and defining an opening 1160 which fluidly communicates between the downstream side of the separator medium 1152 and a continuous phase chamber, e.g., via a stand-off tube. The fitting 1158 may be sealed to the stand-off tube (not shown) by an O-ring or other seal 1156.

Process fluid may be introduced to the coalescer 1130, preferably, into the interior of the coalescer 1130 through the first open end cap 1134 at the first open end. The process fluid then flows from the upstream surface, e.g., the interior surface, of the coalescer 1130 to the downstream surface, e.g., the exterior surface, through the coalescer medium 1132. As the process fluid flows through the coalescer medium 1132, small particles or droplets of discontinuous phase liquid are coalesced to form larger droplets.

From the downstream side of the coalescer 1130, the continuous phase liquid flows past the coalescer 1130 to the separator 1150. However, continuous phase liquid does not pass along or around a flow director. Further, unlike many previous embodiments where much or all of the continuous phase liquid may bend through about 90° or more, e.g., about 180° or more, before contacting a separator, the continuous phase liquid in the fluid treatment system 1100 shown in FIG. 12 may bend through less than 90°, e.g., generally about 45°, to contact the separator 1150 The continuous phase liquid then passes through the separator medium 1152 through the opening 1160 in the fitting 1158 and into the stand-off tube (not shown). From the stand-off tube, the continuous phase liquid may pass into the continuous phase chamber (not shown) and hence to the continuous phase outlet (not shown). The discontinuous phase liquid also flows past the coalescer 1130. Some of the discontinuous phase liquid may then flow past the separator 1150 to the lower portion of the coalesced liquid chamber and some of discontinuous phase liquid may pass in the vicinity of e.g., contact, the separator 1150. As previously described, a separator having a conical, nonpleated configuration may facilitate drainage of the discontinuous phase liquid from the surface of the separator. The discontinuous phase liquid which drains from the separator 1150 may also flow to the lower portion of the coalesced liquid chamber 1122. From the lower portion of the coalesced liquid chamber, the discontinuous phase liquid may pass through the discontinuous phase outlet (not shown).

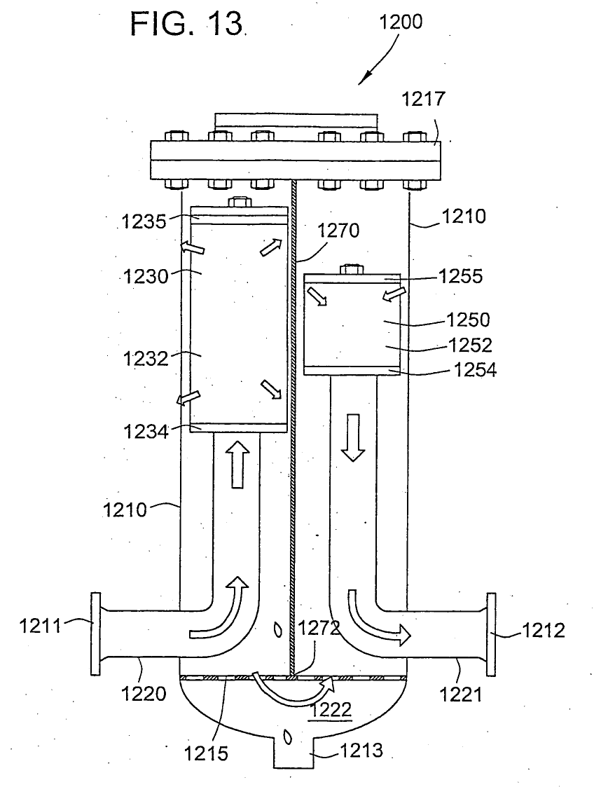

While the invention has been described in some detail by way of illustration and example, the invention is susceptible to various modifications and alternative forms and is not restricted to the specific embodiments set forth. One or more of the features of one embodiment may be combined with one or more of the features of another embodiment. For example, the generally planar flow director of FIG. 3 may be combined with the generally cylindrical or conical flow director of, e.g., FIG. 1, FIG. 2, or FIG. 3 to form a flow director comprising a larger diameter planar flange and a smaller diameter cylindrical or conical skirt depending from the flange. One or more of the features of any embodiment may be modified. For example, the horizontal fluid treatment system 700 shown in FIG. 8 may be modified to form a vertical fluid, or liquid/liquid, treatment system 1200 as shown in FIG. 13. This system 1200 may include many elements, such as a housing 1210, coalescer 1230, flow director 1270 and separator 1250, which may have one or more of the features described with respect to the other embodiments, especially the embodiment shown in FIG. 8. For example, the housing 1210 may include a process fluid inlet 1211, a continuous phase outlet 1212, an inlet pipe 1220, and an outlet pipe 1221; the coalescer 1230 may include a coalescer medium 1232 extending between an open end cap 1234 and a blind end cap 1235; and the separator 1250 may include a separator medium 1252 extending between an open end cap 1254 and a blind end cap 1255. However, the fluid treatment system 1200 is preferably oriented vertically with the cover 1217 on top. The flow director 1270 preferably comprises a barrier partition which is sealed to the cover 1214 and which extends to a perforated support plate 1215 in the lower portion of the housing 1210. Further, the discontinuous phase outlet 1213 is disposed in the lower portion of the coalesced liquid chamber 1222. After the process fluid flows through the coalescer 1230, the continuous phase liquid flows from the downstream side of the coalescer 1030 in a curvilinear flow path through the perforated support plate 1215 around the lower edge 1272 of the flow director 1270 and up to the separator 1250. The discontinuous phase liquid diverges from the curvilinear flow path of the continuous phase liquid and passes to the lower portion of the coalesced liquid chamber 1222 and hence to the discontinuous phase outlet. Further, one or more of the features of any embodiment may be omitted. For example, the flow director 670 of the embodiment shown in FIG. 7 may be omitted. The conical separator 650 may be attached, for example, to the stand-off tube 616 at one end and have a blind end cap attached to the opposite end. The conical separator 650 may then function with two or more coalescers 630 in a manner similar to that of the conical separator 1150 with the single coalescer 1130 shown in FIG. 12. Thus, the described and illustrated embodiments are not intended to limit the invention but, on the contrary, are intended to suggest all modifications, equivalents, and alternatives falling within the spirit and scope of the invention defined in each of the following claims.

All of the information cited herein, including publications, patents, and patent applications, are hereby incorporated in their entireties by reference.

1. A liquid/liquid separation arrangement for separating a discontinuous phase liquid from a continuous phase liquid comprising:
a separator including an upstream surface, wherein the separator resists passage of the discontinuous phase liquid and allows passage of the continuous phase liquid; and
a flow director cooperatively arranged with the separator to direct continuous phase liquid in a curvilinear flow path to the upstream surface of the separator.

2. The liquid/liquid separation arrangement according to claim 1, wherein the separator comprises a conical configuration.

3. The liquid/liquid separation arrangement according to claim 1, wherein the flow director surrounds the separator.

4. The liquid/liquid separation arrangement according to claim 1, wherein the flow director defines a gap upstream of the separator.

5. The liquid/liquid separation arrangement according to claim 4, wherein the gap is uniform.

6. The liquid/liquid separation arrangement according to claim 4, wherein the gap is tapered.

7. The liquid/liquid separation arrangement according to claim 1, wherein the length of the flow director is greater than or substantially equal to the length of the separator.

8. The liquid/liquid separation arrangement according to claim 1, wherein the flow director is attached to the separator.

9. The liquid/liquid separation arrangement according to claim 8, wherein the flow director is attached to an end of the separator.

10. A liquid/liquid separation arrangement for separating a discontinuous phase liquid from a continuous phase liquid comprising:
a separator including a separator medium and
a flow director mounted to the separator.

11-18. (canceled)

19. A liquid/liquid coalescing arrangement for separating a discontinuous phase liquid from a continuous phase liquid comprising:
a coalescer including a downstream surface, wherein the coalescer forms smaller particles of the discontinuous phase liquid into larger droplets; and
a flow director cooperatively arranged with the coalescer to direct the continuous phase liquid in a curvilinear flow path away from the downstream surface to the coalescer.

20. A liquid/liquid coalescing arrangement for separating a discontinuous phase liquid from a continuous phase liquid comprising:
a coalescer including a coalescer medium and
a flow director mounted to the coalescer.

21-24. (canceled)

25. A liquid/liquid treatment arrangement for separating a discontinuous phase liquid from a continuous phase liquid comprising:
a coalescer including a downstream surface;
a separator including an upstream surface; and
a flow director disposed between the downstream surface of the coalescer and the upstream surface of the separator.

26-37. (canceled)

38. A liquid/liquid treatment arrangement for separating a discontinuous phase liquid from a continuous phase liquid comprising:
a hollow coalescer including an interior, an upstream side facing the interior of the coalescer and a downstream side facing away from the interior of the coalescer and
a separator positioned in the interior of the hollow coalescer and isolated from the upstream side of the coalescer.

39-43. (canceled)

44. A liquid/liquid treatment arrangement for separating a discontinuous phase liquid from a continuous phase liquid comprising:
a hollow coalescer including an interior and first and second opposite open ends and
a separator positioned in the interior of the hollow coalescer and isolated from one of the open ends of the coalescer.

45-48. (canceled)

49. A liquid/liquid treatment arrangement for separating a discontinuous phase liquid from a continuous phase liquid comprising:
a coalescer including a coalescer medium and
a separator including a separator medium, wherein the separator comprises a conical configuration and the conical separator points away from the coalescer.

50-53. (canceled)

54. A method for separating a discontinuous phase liquid from a continuous phase liquid comprising:
directing the continuous phase liquid from a coalescer in a curvilinear flow path to a separator.

55-56. (canceled)

57. A method for separating a discontinuous phase liquid from a continuous phase liquid comprising:
diverging the flow paths of the continuous phase liquid from the discontinuous phase liquid, including directing the continuous phase liquid along a curvilinear flow path.

58-59. (canceled)

60. A method for separating a discontinuous phase liquid from a continuous phase liquid comprising:
directing a mixture of the continuous phase liquid and the discontinuous phase liquid into the interior of a hollow coalescer and inside-out from an upstream side of the coalescer to a downstream side through a coalescer medium and
directing the continuous phase liquid into the interior of the hollow coalescer and through a separator which is isolated from the upstream side of the coalescer.

61. (canceled)

62. A method of separating a discontinuous phase liquid from a continuous phase liquid comprising:
directing a mixture of the continuous phase liquid and the discontinuous phase liquid through a first open end of a hollow coalescer and inside-out through a coalescer medium and
directing the continuous phase liquid through an opposite open end of the hollow coalescer and through a separator which is isolated from the first open end of the coalescer.

63. (canceled)
